(19) United States
(12) Patent Application Publication
(10) Pub. No.: US 2012/0141862 A1
(43) Pub. Date: Jun. 7, 2012

(54) ELECTRODE GEOMETRY OF A GALVANIC CELL

(75) Inventors: Tim Schaefer, Niedersachswerfen (DE); Christian Junker, Moritzburg-Orsteil Steinbach (DE)

(73) Assignee: LI-TEC BATTERY GMBH, Kamenz (DE)

(21) Appl. No.: 13/263,112

(22) PCT Filed: Mar. 31, 2010
(86) PCT No.: PCT/EP10/02069

§ 371 Date: Feb. 22, 2012

(30) Foreign Application Priority Data
Apr. 7, 2009 (DE) 10 2009 016 772.2

(51) Int. Cl. H01M 10/04; H01M 2/16; H01M 2/18; B82Y 30/00

(52) U.S. Cl. 429/162; 977/773

(57) ABSTRACT

The invention relates to a galvanic cell (1, 10) which comprises an electrode stack (5). Said stack comprises at least one especially flat anode electrode (2), at least one especially flat cathode electrode (3), and at least one especially flat separator (4) which is interposed between said electrodes (3, 4). The invention is characterized in that the outer contour of the separator (4) has at least one cut-out section (42a, 42b) which is offset inwards with respect to said outer contour.

Priority application DE 10 2009 016 772.2 is fully incorporated by reference into the present application.

The invention relates to a galvanic cell according to the preamble of the claim 1. The invention is illustrated in connection with a Li-ion battery for supplying a motor vehicle drive. It should be noted that the invention can be used independent of the chemistry of the galvanic cell, the design of the galvanic cell or the type of the drive to be supplied.

From the prior art, lithium-ion batteries are known, the galvanic cells of which, in particular due to mechanical damage, can harm the remaining sub-assemblies of the battery or the environment. For example, chemicals can leak from the battery.

It is the object of the invention to make a galvanic cell safer.

This object is solved by a galvanic cell with the features of the claim 1. This object is further solved by a galvanic cell with the features of the independent claim. Preferred and advantageous further developments are subject matter of the dependent claims. A preferred use of the galvanic cell according to the invention is subject matter of an independent claim.

For solving the object, a galvanic cell is proposed, comprising a substantially prismatic electrode stack including at least:

one particularly flat anode electrode,

one particularly flat cathode electrode,

and one particularly flat separator arranged between said electrodes.

It is provided according to the invention that the outer contour of the separator has at least one recess which is offset inwardly with respect to said outer contour.

In the meaning of the invention, a galvanic cell is to be understood as a device which also serves for storing chemical energy and releasing electrical energy. For this purpose, the galvanic cell according to the invention has an electrode stack and an electrolyte. Also, the galvanic cell can be configured to hold electrical energy during charging. This is also called secondary cell or accumulator.

In the meaning of the invention, an electrode stack is to be understood as an apparatus which, as sub-assembly of a galvanic cell, also serves for storing chemical energy and for releasing electrical energy. Prior to releasing electrical energy, stored chemical energy is converted into electrical energy. During the charging, the electrical energy fed to the electrode stack or the galvanic cell is converted into chemical energy and stored. For this purpose, the electrode stack has a plurality of layers, at least one anode electrode, one cathode electrode and one separator layer. The layers are laid on top of each other or stacked, wherein the separator layer is at least partially arranged between an anode layer and a cathode layer. Preferably, this sequence of the layers is repeated several times within the electrode stack. Preferably, some electrodes are in particular electrically interconnected, in particular connected in parallel. Preferably, the layers are wound into an electrode coil.

In the following, the term “electrode stack” is also used for electrode coils.

In the meaning of the invention, an anode electrode or an anode is to be understood as an apparatus which receives electrons during charging and/or stores positively charged interstitial ions. Preferably, the anode is thin-walled; particularly preferred, the thickness of the anode is less than 5% of its longest edge length. Preferably, the anode is limp. Preferably, the anode comprises a metal film or a metallic net structure.

In the meaning of the invention, a cathode electrode or a cathode is to be understood as an apparatus which during discharging or releasing electrical energy also receives electrons and positively charged ions. Preferably, the cathode is thin-walled; particularly preferred, the thickness of the cathode is less than 5% of its longest edge length. Preferably, the cathode is limp. Preferably, the cathode comprises a metal film or a metallic net structure. Preferably, the shape of a cathode corresponds substantially to the shape of an electrode stack. The cathode is also provided for electrochemically interacting with the anode or the electrolyte.

In the meaning of the invention, a separator layer or a separator is also to be understood as an electrically insulating apparatus which separates an anode from a cathode and spaces them apart. Also, the separator layer or the separator receives at least partially an electrolyte, wherein the electrolyte preferably contains lithium-ions. The electrolyte is also electrochemically connected in an operative manner to adjacent layers of the electrode stack. Preferably, the shape of a separator corresponds substantially to the shape of an anode of the electrode stack. Preferably, a separator is formed in a thin-walled manner, particularly preferred as microporous film. Preferably, the separator layer or the separator is wetted with an additive which also increases the mobility of the separator layer or the separator. Particularly preferred, the wetting takes place with an ionic additive. Preferably, the separator layer or the separator extends at least in sections over a boundary edge of at least one electrode. Particularly preferred, the separator layer or the separator extends beyond all boundary edges of adjacent electrodes.

In the meaning of the invention, a recess is to be understood as a region of a layer of the electrode stack which is incomplete with respect to its outer contour or is missing. Preferably, such a missing spot is located within the outer contour and touches or, according to the invention, intersects the outer contour. The outer contour of a separator or also of an electrode is the plan view of the same with respect to a plane which extends transverse and preferably perpendicular to the stacking direction. Preferably, a recess is bounded in a curved manner. It is preferred provided that a multitude of anode electrodes, cathode electrodes and separators are comprised in the electrode stack. Here, only one separator can be provided with at least one recess or a plurality of separators can be provided with at least one recess. Preferably, all separators are formed with at least one recess.

An advantage of the solution according to the invention is that by a recess, space is created in the separator for contacting an electrode. The contacts protrude only partially out of the outer contour of the electrode stack. In case of an embodiment according to the invention of a galvanic cell, the contacts can be attached in protected areas of a battery which in case of an accident of the motor vehicle are less likely subjected to harmful influences. In case of the occurrence of harmful forces, for example in case of an accident of the motor vehicle, the operational safety of a galvanic cell is in particular increased in that also the contacts are arranged in protected areas of a galvanic cell or a battery. Thus, the underlying object is solved.

Below, further advantageous embodiments of the invention are described.

Advantageously, a recess of a separator is substantially covered by an electrode of the same electrode stack. Said electrode protrudes in the region of the recess of the separator and, seen in plan view, covers from below or above said recess in the separator. The wording “substantially” means here that the recess does not have to be completely covered. Preferably, the electrode involves an electrode adjacent to the separator within the electrode stack. Thus, the accessibility for electrically contacting the electrode covering the recess is improved. Therefore, e.g., other electrical contacting means and/or a larger contacting area is possible compared to the prior art, whereby the safety is improved. Preferably, the region of the contacts of the electrodes does not protrude beyond the outer contour of the electrode stack.

It is provided in an advantageous manner that the separator has at least two recesses of which within the electrode stack, a first cut-out section is substantially covered by an anode electrode and a second cut-out section is substantially covered by a cathode electrode. Preferably, this involves the electrodes adjacent to the separator.

It is provided in an advantageous manner that the electrode stack comprises a multitude of separators, the recesses of which are substantially covered in an alternating and preferably reciprocating manner by an anode electrode and a cathode electrode. Also in this case, the covering is preferably carried out by the electrodes adjacent to the separator. Thereby, the safety of the galvanic cell according to the invention can be further improved. This is explained in more detail hereinafter in connection with the figures.

For solving the object, furthermore, a galvanic cell is proposed, comprising an electrode stack with at least

one particularly flat anode electrode (anode),

one particularly flat cathode electrode (cathode),

and one in particular flat separator which is arranged between said electrodes. It is provided according to the invention that the outer contours of the electrodes and the separator each have at least one recess which is offset inwardly with respect to said outer contour, wherein said recesses are substantially arranged or aligned one on top of the other. One advantage of this solution is that the recesses arranged on top of each other within the electrode stack provide installation space which can be utilized for safety-increasing measures, as explained in more detail below, without the need to change the outer structural dimensions of the galvanic cell. However, safety-increasing measures known from the prior art often result in a constructional outer oversize and thus are a disadvantage in terms of the outer structural dimensions.

Advantageously, it is provided that the electrodes each have a substantially rectangular outer contour or plan view and each have at least one recess. Preferably, the electrodes are arranged in the electrode stack in such a manner that the recesses of at least two electrodes of the same polarity substantially coincide, but that the recesses of electrodes of different polarity do not coincide. Preferably, the at least one separator has a plurality of recesses which are provided to substantially coincide within the electrode stack with recesses in electrodes. In the meaning of the invention, “across corners” is to be understood such that within the electrode stack a first recess of the at least one separator coincides with a recess of at least one first electrode and is substantially covered by at least one electrode of opposite polarity. A second recess of the at least one separator is substantially covered by at least one first electrode and coincides with a recess of at least one electrode of opposite polarity. Preferably, two recesses of a separator are formed in particular at adjacent corners of the rectangular outer contour. The wording “substantially” means here that minor deviations from a rectangular shape are also possible.

Advantageously, it is provided that at least one cut out of a separator has a concave shape or a concave contour. Likewise, it is preferred provided that at least one recess of an electrode has a convex shape or a convex contour. These shapes, among other things, are advantageous with respect to mechanical loads. It is in particular provided that said shapes, in particular at the transition points, are formed in a tangentially continuous manner.

Advantageously, it is provided that the electrodes arranged on top of each other within the electrode stack form at least one channel. Preferably, at least one terminal feedthrough is arranged in said channel. The longitudinal orientation of said channel corresponds substantially to the stacking direction. By an offset arrangement of the recesses, a course of the channel extending obliquely with respect to the stacking direction is also possible. A terminal feedthrough in the meaning of the invention is also provided so as to connect electrodes to each other, in particular a plurality of electrodes of the same polarity. Preferably, a terminal feedthrough is configured in an electrically conductive manner, in particular with a metal and/or graphite. Preferably, it is provided that the cross-section of a terminal feedthrough is adapted to the cross-section of the channel. The cross-section is defined in each case through shape and size of the area. The cross-section of the channel is substantially determined by the shape of the recesses. The cross-section of the terminal feedthrough can in particular be oval, round or polygonal. Preferably, it is provided that the terminal feedthrough does not protrude beyond the outer contours of the electrodes or the separator. Preferably, it is provided that the cross-section over the longitudinal extension is constant. Apart from that, a channel formed by the recesses can also be used for arranging electrical lines and/or a battery management system (BMS). Preferably, at least one electrode region which in an electrode stack substantially covers a recess of the at least one separator has a recess. Preferably, said recess is arranged in the region of a channel of the electrode stack. Preferably, in each case at least two electrodes of different polarity each have one recess. Preferably, the shape of a recess is adapted to a terminal feedthrough. Preferably, a terminal feedthrough is guided through a plurality of recesses of electrodes of the same polarity. Preferably, a terminal feedthrough is electrically connected in the region of a feedthrough to an electrode. Preferably, the recesses of a plurality of electrodes of the same polarity coincide.

Advantageously and preferably, a separator is used which consists of a substance-permeable carrier, preferably partially substance-permeable, thus substantially permeable with respect to at least one material and impermeable with respect to at least one other material. The carrier is coated on at least one side with an inorganic material. As substance-permeable carrier, preferably, an organic material is used which preferably is configured as nonwoven fabric. Said organic material, preferably a polymer and particularly preferred polyethylene-terephthalate (PET), is coated with an inorganic ion-conductive material which is preferably ion-conductive in a temperature range of −40 ° C. to 200 ° C. The inorganic ion-conductive material preferably comprises at least one compound from the group of oxides, phosphates, sulfates, titanates, silicates, aluminosilicates with one of the elements Zr, Al, Li, particularly preferred zirconium oxide. Preferably, the inorganic ion-conductive material has particles with a largest diameter of less than 100 nm. Such a separator is distributed for example under the trade name “Separion” by the Evonik AG in Germany.

Preferably, it is provided that the separator protrudes with respect to the outer contour of the electrodes. The separator protrudes preferably with a substantially uniform protrusion of up to 5 mm and particularly preferred with a substantially uniform protrusion of up to 3 mm. The mentioned protrusion ranges have proved in test runs of a galvanic cell according to the invention to be particularly advantageous. Notwithstanding this, the electrodes and the separators have substantially congruent geometries or outer contours, except for the respective recesses which coincide only partially.

Advantageously, a galvanic cell according to the invention has an enclosure with a sealing region. Said enclosure serves also for separating the electrode stack and the electrolyte in particular in a gas-tight manner from the environment. Preferably, said enclosure is in particular firmly bonded in the sealing region with the electrode stack. Preferably, said enclosure is in particular firmly bonded in the sealing region with two electrodes of different polarity. Preferably, the enclosure is configured as composite film. Preferably, the composite film also comprises a metal, in particular aluminum. Preferably, the sealing region extends at least partially along a recess of an electrode and/or a separator. Preferably, at least one electrode extends out of the enclosure. Preferably, at least two electrodes of different polarity extend at least partially out of the enclosure. Preferably, an electrode region extending out of the enclosure has a recess. Preferably, a terminal feedthrough is guided through said recess and is connected in the region of the recess to the electrode in an at least electrically conductive manner. Preferably, a region of at least one electrode extends with a recess out of the enclosure. Preferably, the enclosure has a hole in the region of a recess in an electrode and is in particular firmly bonded around said hole with said electrode.

Advantageously, a sealing region is designed in consideration of applied stress which occurs during the operation of the galvanic cells. Stress applied to the sealing region is to be understood in particular as stress due to temperature, pressure, forces acting on the enclosure, loads applied by the surroundings, atmosphere or chemicals. During the operation, in particular shear stress and/or peeling stress can occur in the sealing region which is to be counteracted by an appropriate configuration of said sealing regions. Preferably, a sealing region is wider in certain regions, in particular in regions of increased shear stress. Preferably, a sealing region is wider in the region of a corner of the electrode stack or an electrode. Preferably, in particular an arc-shaped profile of a sealing region is formed wider. Preferably, the enclosure has a greater wall thickness in certain regions in the sealing region. Thus, in addition, the durable sealing of the galvanic cell is improved.

Advantageously, a battery has at least two galvanic cells according to the invention. Preferably, electrode and/or separator recesses arranged on top of each in the electrode stack form at least one channel in which at least one terminal feedthrough is arranged. Preferably, regions having a recess of at least two electrodes of different polarity of at least one galvanic cell extend out of the enclosure of the latter. Preferably, two recesses of a separator are substantially covered by at least two electrodes of different polarity, in particular by in each case one region of two electrodes of different polarity which each have at least one recess. Preferably, a terminal feedthrough is guided through recesses of electrodes of different galvanic cells and connected to the same at least in an electrically conductive manner. Preferably, a terminal feedthrough has at least two electrically conductive regions, wherein these at least two regions are electrically insulated with respect to each other. Preferably, the at least two galvanic cells are in particular connected in series by means of a terminal feedthrough.

Preferably, a galvanic cell according to the invention is installed in a motor vehicle having an electric drive or a hybrid drive. Preferably, a galvanic cell according to the invention is used for supplying a drive of a motor vehicle.

Further advantages, features and possibilities of use arise from the following exemplary description in connection with the figures. Identical or identically acting components are designated herein by the same reference numbers. In the figures:

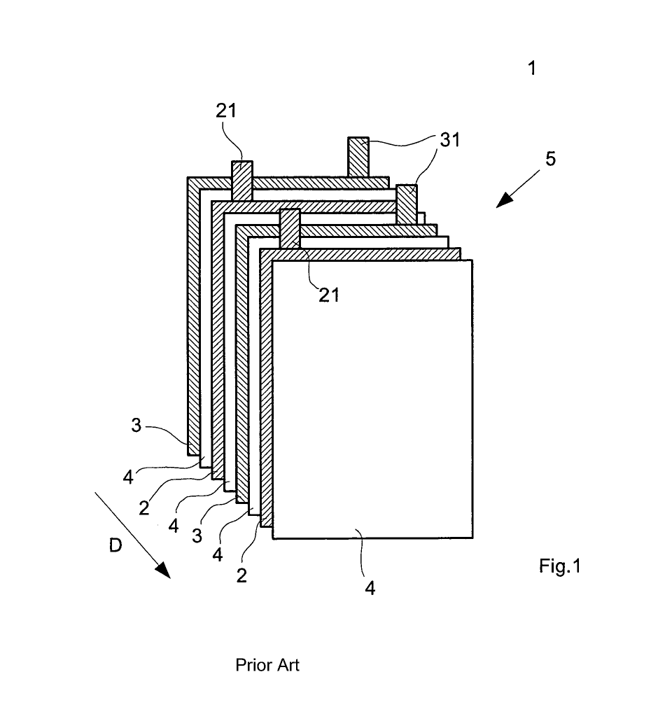

FIG. 1 shows the schematic stack structure of a galvanic cell according to the prior art in a perspective view;

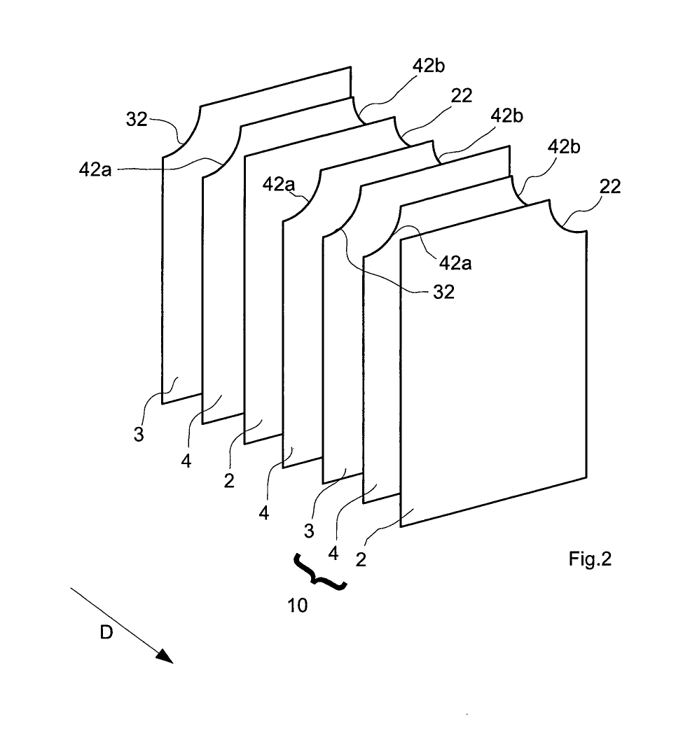

FIG. 2 shows the arrangement of electrodes and separators according to a first exemplary embodiment in a perspective view;

FIG. 3 shows a separator and adjacent electrodes according to the exemplary embodiment of FIG. 2 in a top view;

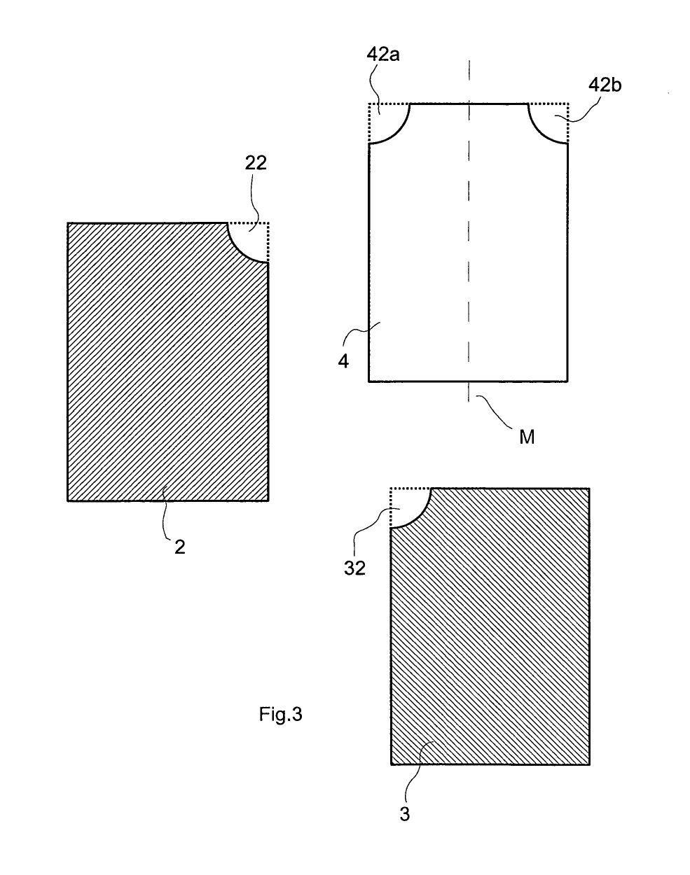

FIG. 4 shows the arrangement of electrodes and separators according to a second exemplary embodiment in a perspective view;

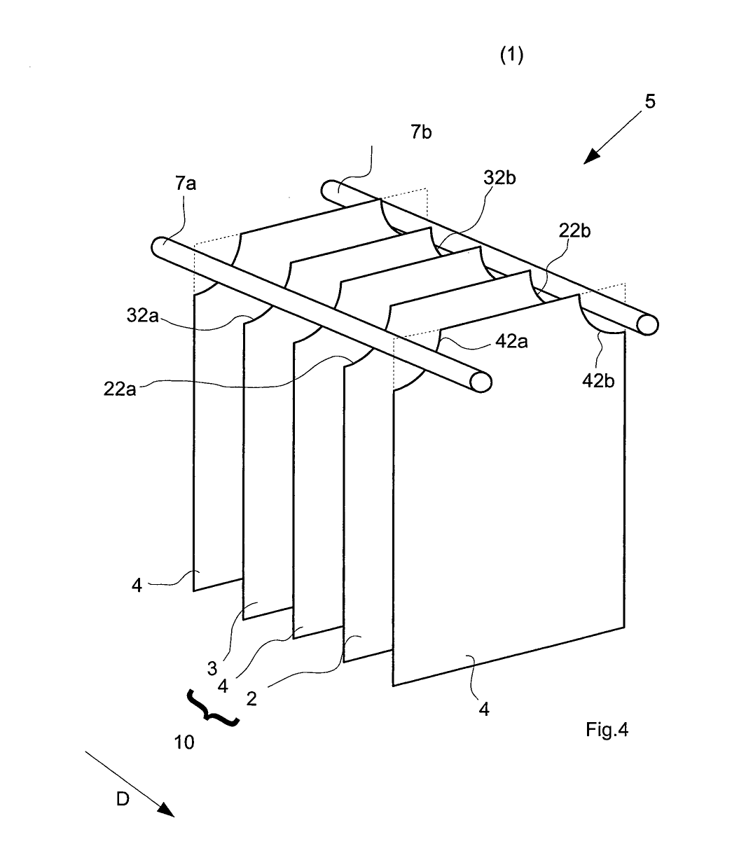

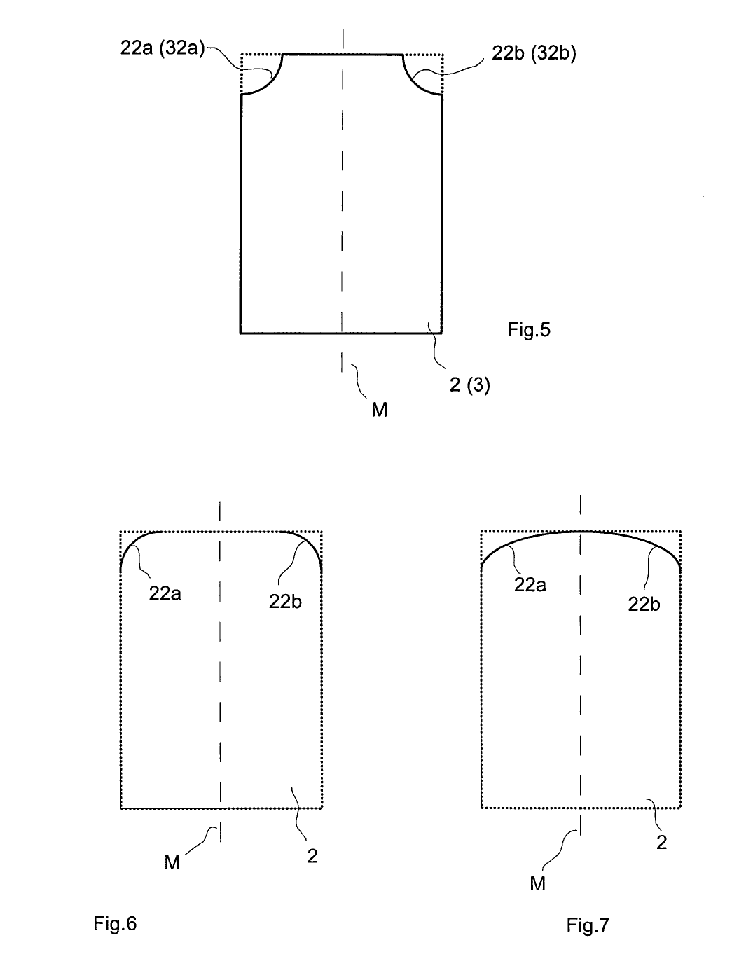

FIG. 5 shows an electrode according to the exemplary embodiment of FIG. 4 in a top view;

FIG. 6 shows an alternative embodiment of an electrode according to the invention in a top view;

FIG. 7 shows a further embodiment of an electrode according to the invention in a top view;

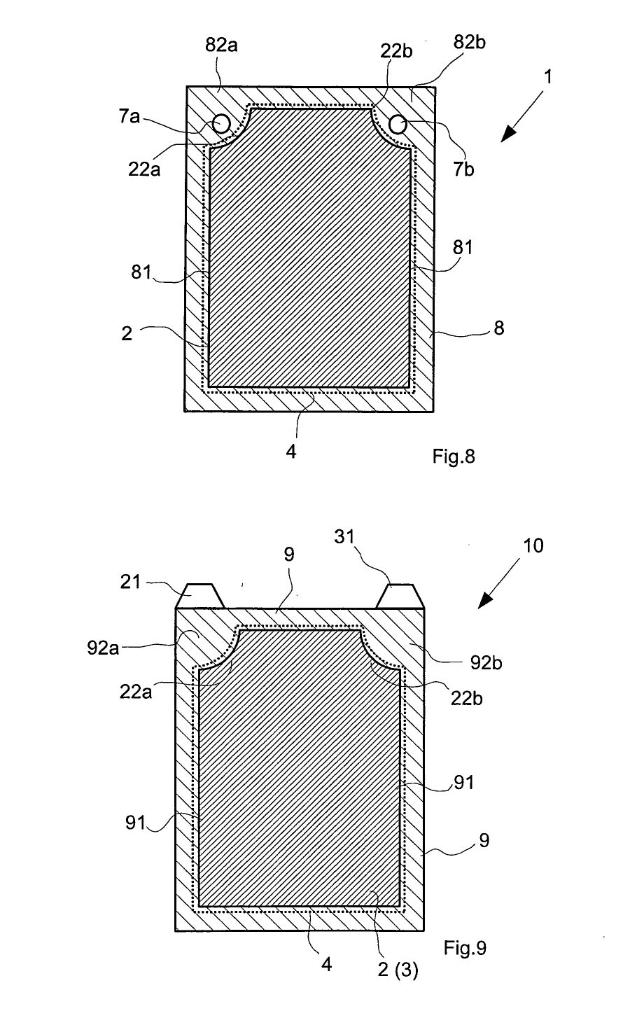

FIG. 8 shows a galvanic cell according to the invention with enclosure and terminal feedthroughs in a schematic side view;

FIG. 9 shows a further galvanic cell with enclosure in a schematic sectional view;

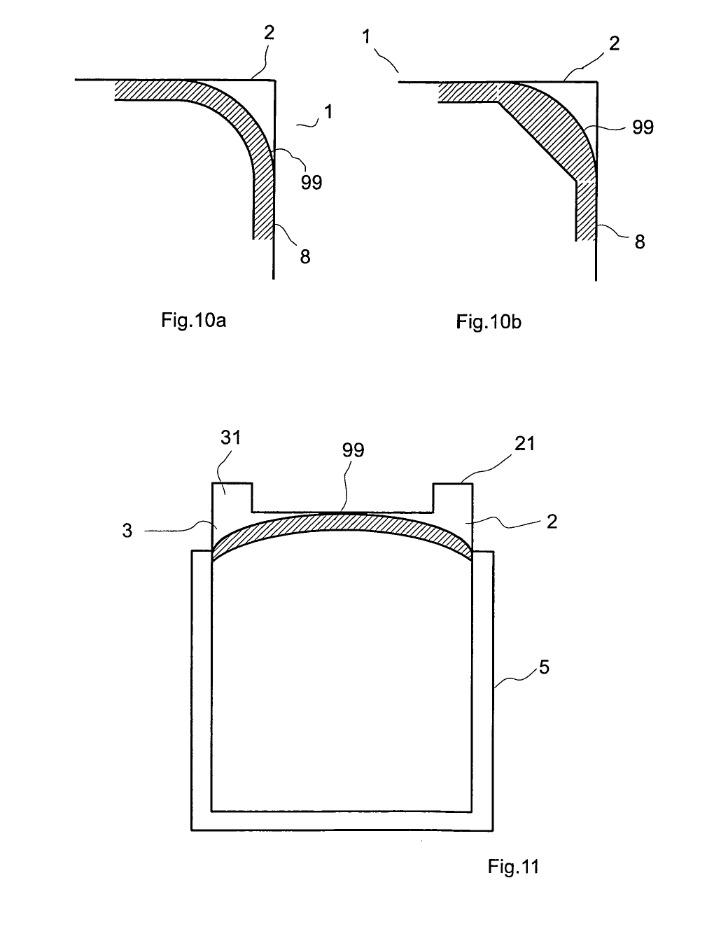

FIG. 10 shows configurations of a sealing region of a galvanic cell according to the invention in a top view;

FIG. 11 shows a further embodiment of a galvanic cell according to the invention with adapted electrodes in a top view;

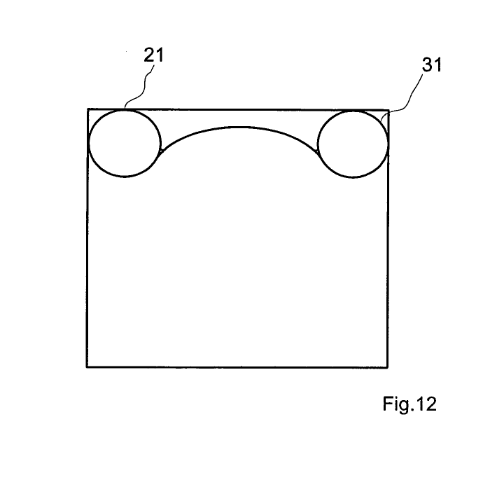

FIG. 12 shows a further embodiment of a galvanic cell according to the invention with adapted electrodes in a top view;

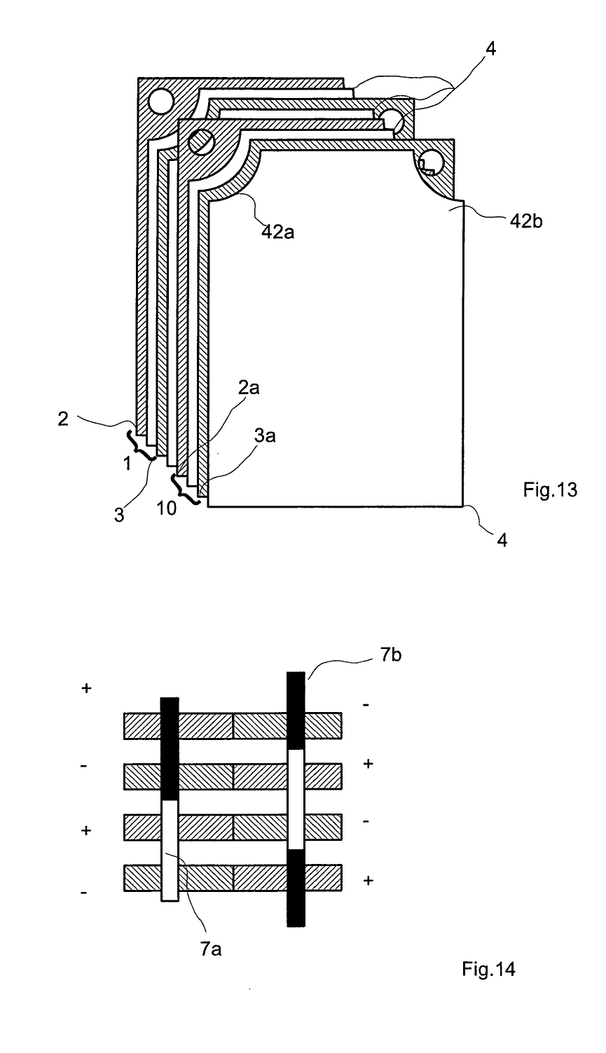

FIG. 13 shows the electrode stacks of two galvanic cells according to the invention in a perspective view;

FIG. 14 shows a series connection of four galvanic cells according to the invention.

FIG. 1 shows the structure of a galvanic cell 1 according to the prior art. This cell comprises a plurality of anode electrodes 2, cathode electrodes 3 and separators 4 which are formed as flat rectangular stack sheets and are alternately arranged or stacked into an electrode stack 5. The stacking direction is indicated with the arrow D.

From the prior art, different arrangement sequences for the stack sheets are known. The electrodes 2 and 3 are provided with contact elements 21 and 31 which are formed as contact lugs and protrude out of the electrode stack 5. Terminal feedthroughs or arresters, which are not shown, connect the contact elements 21 and 31 of a plurality of identical electrodes 2 or 3 to each other. These terminal feedthroughs serve for introducing a charging current and/or for discharging a useful current. An enclosure for the electrode stack 5 is not shown here.

FIG. 2 shows an arrangement of electrodes 2 and 3 and separators 4 according to a first exemplary embodiment of the invention. The separators 4 each have two recesses 42a and 42b which according to the illustration are formed in the upper region in the corners on the right and left sides. The anode electrodes 2 each have one recess 22 in the upper region on the right side. The cathode electrodes 3 each have one recess 32 in the upper region on the left side. With the upper corner which does not have a recess, the electrodes 2 and 3 cover in the electrode stack 5 in each case one recess 42a or 42b of an adjacent separator 4. Thus, this results in a structure of the stack 5 in which the recesses 42a and 42b on the right and the left sides of a separator 4 are covered in alternating and reciprocating manner by an anode electrode 2 and a cathode electrode 3. Despite the recesses 22, 32, 42a and 42b, the risk of an electrical short circuit between electrodes 2 and 3 of opposite polarity can be avoided by this structure. On the other hand, the recesses 22, 32, 42a and 42b allow a better electrical contacting of the electrodes 2 and 3, e.g. by using electrical contacting means which were previously not used, and/or a larger contact area than in prior art solutions is made possible.

FIG. 3 shows a separator 4 and electrodes 2 and 3 used in the exemplary embodiment of FIG. 2 in a top view, i.e. viewed counter to the stacking direction D. The separator 4 is a few millimeters larger than the electrodes 2 and 3 and thus protrudes in the electrode stack 5 beyond the outer contours of the electrodes 2 and 3, as illustrated above. The separator 4 has two recesses 42a and 42b. These recesses 42a and 42b are formed substantially mirror-symmetrically with respect to a center line M. The anode electrode 2 has a recess 22 and the cathode electrode 3 has a recess 32. The recesses 22, 32, 42a and 42b are formed in the corners and each of them has a concave contour. However, the recesses can have any other shape or contour as explained in more detail hereinafter in connection with a second exemplary embodiment.

FIG. 4 shows the arrangement of electrodes 2 and 3 and separators 4 according to a second exemplary embodiment of the invention. The separators 4 and electrodes 2 and 3 each have two recesses 42a, 42b, 22a, 22b, 32a and 32b which are formed with a concave profile across corners at two adjacent upper corners. The separators 4 have a geometry which is substantially identical to the one of the electrodes 2 and 3; however, here too, they protrude with respect to the outer contour of the electrodes 2 and 3, preferably with a uniform protrusion as explained above.

In the electrode stack 5, the recesses 22a, 22b and 32a, 32b of the electrodes 2 and 3 as well as the recesses 42a and 42b of the separators 4 form two channels in each of which one terminal feedthrough 7a and 7b for contacting the electrodes 2 and 3 is arranged. The terminal feedthroughs 7a and 7b are here in each case only in contact with the respective electrode 2 or 3 which can be achieved, e.g. by varying shape and/or size of the recesses 22a, 22b, 32a and 32b and/or other contacting means. Said contacts are not illustrated in detail.

The arrangement shown in FIG. 4 has many advantages: Due to the arrangement of the terminal feedthroughs 7a and 7b in the channels formed by the recesses 22a, 22b, 32a, 32b and 42b, the contact elements 21 and 31 of the electrodes 2 and 3, which contact elements protrude from the electrode stack as illustrated in FIG. 1 are eliminated. Thus, the galvanic cell 1 can be designed to be more compact with respect to its outer dimensions. The terminal feedthroughs 7a and 7b are arranged in such a manner that they do not protrude beyond a rectangular outer contour of the electrodes 2 and 3 and the separators 4 which likewise contributes to a compact design. With respect to its outer dimensions, the energy density of the galvanic cell 1 is therefore virtually increased.

Moreover, an enclosure in the region of the recesses 22a, 22b, 32a, 32b, 42a and 42b can be designed more solid and thus more robust, whereby the local mechanical strength and therefore the safety is significantly increased without compromising a compact design. This is illustrated in more detail below in connection with the FIGS. 8 and 9.

FIG. 5 shows an electrode of the exemplary embodiment of FIG. 4 in a top view, i.e. viewed counter to the stacking direction D. This electrode involves an anode electrode 2 or a cathode electrode 3. The electrode 2 or 3 has two recesses 22a and 22b (32a and 32b, respectively) which are formed with a concave profile across corners at two adjacent corners. The recesses 22a and 22b are configured to be substantially mirror-symmetrically to a center line M of the electrodes 2 and 3, wherein, however, the recesses 22a and 22b do not necessarily have to be identical. A separator 4 has a substantially identical geometry, regardless of its protrusion. It is not illustrated in the figure that an electrode 2 preferably has only one recess 22a or 22b which substantially covers a recess of an adjacent separator in the electrode stack.

FIG. 6 shows a differing embodiment for an electrode 2 or 3. The recesses 22a and 22b have a convex profile. An associated separator 5 is preferably configured in the same manner. Also, the cross-sections of the terminal feedthroughs 7a and 7b are preferably adapted to said recesses 22a and 22b. It is not illustrated in the figure that an electrode 2 preferably has only one recess 22a or 22b which substantially covers an adjacent separator in the electrode stack.

FIG. 7 shows a further embodiment of an electrode 2 or 3. The recesses 22a and 22b are configured here in such a manner that they reach substantially up to the center line M of the electrode 2, whereby the electrode is formed in an arc-shaped manner at its upper outer contour edge. An associated separator 5 is preferably configured in the same manner. Such a configuration is particularly advantageous with respect to the mechanical material stresses there in particular in an enclosure, as explained in more detail below. It is not illustrated in the figure that an electrode 2 preferably has only one recess 22a or 22b which substantially covers a recess of an adjacent separator in the electrode stack.

As shown in the FIGS. 5, 6 and 7, it is preferred to form the recesses 22a and 22b or 32a and 32b at the upper corners of an electrode 2 and 3, respectively. The same applies with respect to a separator 4. The designation “upper” relates to the preferred vertical installation position. Differing from this, the recesses 22a and 22b or 32a and 32b can also be formed at the lower corners. A diagonal arrangement is also possible. The configuration and arrangement possibilities for the recesses are usually always determined by the space requirements. In addition, it is also possible that only one recess is provided or more than two recesses can be provided. Instead of a rectangular outer contour of the electrodes 2 and 3, a different outer contour is also possible such as e.g. a circular shape, triangular shape or barrel shape. The same applies to a separator 4.

FIG. 8 shows schematically the enclosure of a galvanic cell 1 in a schematic sectional view. The enclosure 8 surrounds the stacked electrodes 2 and 3 and the protruding separators 4 and provides also for the mechanical bond of the galvanic cell 1. The enclosure 8 can connect to the electrodes 2 and 3 and the separators 4 in the region of their outer contour edges in a form-fitting and/or material-bonding manner as schematically indicated by the dashed regions 81. This increases the mechanical strength of the galvanic cell 1.

In the region of the illustrated recesses 22a and 22b, the enclosure 8 is formed in such a manner that the result is a desired rectangular outer contour for the galvanic cell 1, whereby in the region of said recesses 22a and 22b, a material accumulation 82a and 82b, i.e. an increased wall thickness, from enclosure material exists. The material accumulations 82a and 82b increase locally the mechanical strength of the galvanic cell 1 without compromising the outer structural dimensions.

Inside the material accumulations 82a and 82b of the enclosure 8, the terminal feedthroughs 7a and 7b are integrated, whereby the latter are firmly fixed and are electrically insulated in an excellent manner. However, the terminal feedthroughs 7a and 7b do not have to be arranged in these regions, but, e.g., can also extend laterally.

FIG. 9 shows the enclosure 9 of a galvanic cell 10 from an enclosure material 9. As illustrated above, a galvanic cell 10 is formed from an anode electrode (anode) 2, a cathode electrode (cathode) 3 and a separator 4 arranged between said electrodes. Enclosing this unit serves for mechanical protection of the galvanic cell 10 and is intended to prevent electrolyte from leaking and/or outgassing. Preferably, the enclosure 9 is formed from a sealing film, in particular from a composite film.

The enclosure 9 can connect to the electrodes 2 and 3 and the separators 4 in the region of their outer contour edges in a form-fitting and/or material-bonding manner as schematically indicated by the dashed regions 91. This increases the mechanical strength of the galvanic cell 10. In the region of the illustrated recesses 22a and 22b, the enclosure 9 has material accumulations 92a and 92b. These material accumulations 92a and 92b increase locally the mechanical strength of the enclosure 9 and also improve the sealing in these critical regions. Further, a potential sealing seam in the region of said recesses 22a and 22b can be made wider. Contact elements or contact lugs 21 and 31 can be formed so as to penetrate through the enclosure 9, as illustrated in FIG. 9. The internal contacts are not illustrated in detail.

In case of a galvanic cell having rectangular stack sheets, in particular the corner regions of an enclosure 9 are highly mechanically stressed because here, due to the load, shear stress peaks occur in the enclosure or housing material which, e.g. result from torsional load acting on the galvanic cell 1. Due to material accumulations of housing or enclosing material in the region of the recesses 22a, 22b, 32a, 32b, 42a and 42, the local strength in these regions is significantly increased. Therefore, it is preferred to arrange any recesses in spatial proximity to such mechanically highly stressed regions. The edge-free, e.g. concave profile of a recess facilitates in addition a harmonic force flow in these regions.

FIG. 10 shows two formations of a sealing region 99 of a galvanic cell 1 according to the invention with enclosure 8, 9. FIG. 10a shows how the enclosure 8, 9 extends preferably rounded in the region of a corner of an electrode 2, 3. In this manner, peeling of the enclosure 8, 9 from the electrode 2, 3 in particular in the proximity of a corner of the electrode 2, 3 can be reduced. Here, the sealing region 99 has a uniform width. FIG. 10b shows how the width of the sealing region 99 in the proximity of a corner of the electrode 2, 3 is preferably adapted in particular to the course of the shear stress.

FIG. 11 shows a further embodiment of a galvanic cell according to the invention with adapted electrodes 2, 3. The electrode stack is enclosed by the enclosure 8. The sealing region 99 is adapted to the rounded profile of the edge delimiting the enclosure 8, wherein in the sealing region 99, the enclosure 8 is adapted to the separator. In the region of a corner, an electrode 2, 3 is provided in each case with rounded contact lugs 21, 31. Said contact lugs 21, 31 extend preferably into a region of the galvanic cell or the battery which is only minimally subjected to the risk of mechanical damage.

FIG. 12 shows a further embodiment of a galvanic cell according to the invention with adapted electrodes 2, 3. In the region of a corner, an electrode 2, 3 is provided in each case with a contact element 21, 31. Here, the contact elements 21, 31 do not extend outside of an imaginary rectangular outer contour which is illustrated with a dashed line. Thus, apart from the particularly protected arrangement of the contact elements 21, 31, installation space is saved as well.

FIG. 13 shows the electrode stacks of two galvanic cells 1, 10. The enclosures of the galvanic cells 1, 10 are not illustrated. The electrode stacks are composed in substantially the same manner. A substantially rectangularly formed separator 4 has a first recess 42a and a second recess 42b which are arranged at the upper corners. A substantially rectangularly formed electrode 2, 2a, 3, 3a has in each case one recess which is arranged at a corner. Another corner of an electrode has a recess which is adapted to the substantially circular cross-section of a terminal feedthrough. The electrodes of a first polarity cover substantially a first recess 42a of the separators arranged adjacent in the electrode stack. The electrodes of a second polarity cover substantially a second recess 42b of the separators arranged adjacent in the electrode stack. The regions of electrodes covering the recesses of the separators have recesses through which terminal feedthroughs 7a, 7b extend. In the figure, the galvanic cells 1, 10 are connected in parallel.

FIG. 14 shows a parallel connection of four galvanic cells. Here, every second galvanic cell is arranged in a mirror-inverted manner. The terminal feedthroughs are guided through recesses in the electrodes. A terminal feedthrough has preferably at least two current-conductive regions which are electrically insulated with respect to each other.

1.-13. (canceled)

14. A galvanic cell (1, 10), comprising a substantially prismatic electrode stack (5) with at least:
one flat anode electrode (2),
one flat cathode electrode (3),
and one flat separator (4) which is arranged between said electrodes (2, 3) in such a manner that the outer contour of the separator (4) has at least one recess (42a, 42b) which is offset inwardly with respect to said outer contour,
wherein the electrode stack (5) at least one electrode (2, 3) covers this recess (42a, 42b).

15. The galvanic cell (1, 10) according to claim 14, wherein the separator (4) has at least two recesses (42a, 42b) of which in the electrode stack (5), a first one is substantially covered by an anode electrode (2) and a second one is substantially covered by a cathode electrode (3).

16. The galvanic cell (1, 10) according to claim 15, wherein the electrode stack (5) comprises a plurality of separators (4), the recesses (42a, 42b) of which are substantially covered in an alternating and reciprocating manner by an anode electrode (2) and a cathode electrode (3).

17. The galvanic cell (1, 10) according to claim 14, comprising a prismatic electrode stack (5) with at least:
one flat anode electrode (2),
one flat cathode electrode (3),
and one flat separator (4) which is arranged between said electrodes (2, 3), wherein
that the outer contours of the electrodes (2, 3) and the separator (4) each have at least one recess (22, 22a, 22b, 32, 32a, 32b, 42a, 42b) which are offset inwardly and are arranged on top of each other in the electrode stack (5).

18. The galvanic cell (1, 10) according to claim 17, wherein the electrodes (2, 3) and the separator (4) each have a rectangular outer contour, that at least one recess (22, 22a, 32, 32a, 42a) is formed across corners and that two recesses ((22, 22a, 22b, 32, 32a, 32b, 42a, 42b) are formed across corners.

19. The galvanic cell (1, 10) according to claim 18, wherein at least one recess (22, 22a, 22b, 32, 32a, 32b, 42a, 42b) has an arc-shaped boundary which extends in a concave or convex manner.

20. The galvanic cell (1, 10) according to claim 19, wherein the recesses (22, 22a, 22b, 32, 32a, 32b, 42a, 42b) arranged on top of each other in the electrode stack (5) form at least one channel in which at least one terminal feedthrough (7a, 7b) is arranged, wherein the cross-section of a terminal feedthrough (7a, 7b) is adapted to the cross-section of the channel.

21. The galvanic cell (1, 10) according to claim 20, characterized in that the galvanic cell (1, 10) has at least one separator (4) which preferably consists of a partially substance-permeable, thus permeable with respect to at least one material and impermeable with respect to at least one other material,
wherein the carrier is coated on at least one side with an inorganic material,
wherein as substance-permeable carrier preferably an organic material is used which is preferably configured as nonwoven fabric,
wherein the organic material preferably comprises a polymer and particularly preferred polyethylene-terephthalate (PET),
wherein the organic material is coated with an inorganic ion-conductive material which is preferably ion-conductive in a temperature range of −40° C. to 200° C.,
wherein the inorganic ion-conductive material is at least one compound from the group of oxides, phosphates, sulfates, titanates, silicates, aluminosilicates of at least one of the elements Zr, Al, Li, in particular zirconium oxide,
and wherein the inorganic ion-conductive material has particles with a largest diameter of less than 100 nm.

22. The galvanic cell (1, 10) according to claim 21, wherein the separator (4) protrudes with respect to the outer contour of the electrodes (2, 3), with a uniform protrusion of up to 5 mm and with a uniform protrusion of up to 3 mm.

23. The galvanic cell (1, 10) according to claim 22, wherein the galvanic cell (1, 10) has an enclosure (8, 9) with a sealing region (99) and that said sealing region (99) is firmly bonded with the electrode stack (5), with the outer electrodes (2, 3) of the same.

24. The galvanic cell (1, 10) according to claim 1023 wherein the sealing region (99) is formed in consideration of at least one stress situation occurring during the operation of the galvanic cell (1, 10).

25. A battery having at least two galvanic cells (1, 10) according to claim 24, wherein a terminal feedthrough (7a, 7b) is connected in an electrically conductive manner to the at least two galvanic cells (1, 10).
